(19) United States
(12) Patent Application Publication
(10) Pub. No.: US 2005/0206038 A1
(43) Pub. Date: Sep. 22, 2005

(54) Apparatus and method for knurling material

(76) Inventors: Henri Brisebois, Lachenaie (CA); Denis White, Mascouche (CA); Stephane Bucher, St-Hilaire (CA)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 10/805,707

(22) Filed: Mar. 22, 2004

(51) Int. Cl. B29C 33/40

(52) U.S. Cl. 264/284; 264/219; 156/209; 425/363

(57) ABSTRACT

The present invention provides a die for impressing a material between the die and an anvil such as to apply a compressive force to the material. The die comprises a plurality of fields. Each of the fields includes at least two projections arranged to engage the material substantially simultaneously. In addition each of the fields is characterized by a total contact area over which the compressive force is applied. The total contact area of each field is defined by the projections of the respective field. The total contact area of each field is substantially uniform from one field to another such that the pressure applied by each individual field on the die is not more than double the pressure applied by any other individual field on the die.

### FIELD OF THE INVENTION

The present invention relates to a die for knurling sheet materials and in particular, but not limited to, a roller die for knurling sheet materials in the manufacture of an article.

### BACKGROUND OF THE INVENTION

Knurling is a process by which materials are subjected to a compressive force at a plurality of locations over their surface through the application of knurls, which are projections that extend from an otherwise relatively smooth surface. Knurling allows a material to be embossed or otherwise deformed at discrete points. Knurling also allows a material to be sealed by the application of force, and optionally heat.

FIGS. 1 and 2 show an example of a conventional knurling apparatus for sealing two sheets of material together in the manufacture of an article. A knurling apparatus generally shown at FIG. 1 comprises a cylindrical die roller 3 having a cylindrical surface 5, which is arranged to rotate about its axis of rotation 7. A pattern of projections, typically in the form of frustrums (i.e. cylinders, truncated pyramids, or cones) are formed over the surface of the die roller 3 in a pattern which is configured to join the sheets of material together at the required positions. In this example, the projections are configured to form a seal around the peripheral edge of a sanitary napkin.

The apparatus further comprises a cylindrical anvil roller 11 having a generally smooth cylindrical surface and an axis of rotation 13 that is generally parallel to the axis of rotation 7 of the die roller 3. The anvil roller 11 and the die roller 3 are arranged such that their cylindrical surfaces lie opposite each other and are spaced to form a narrow gap 15 therebetween for the passage of the sheets of material to be sealed. The die roller 3 and anvil roller 11 are spaced apart such that as they are rotated and the sheets of material pass through the narrow gap 15, the region of projections on the die roller 3 closest to the cylindrical surface of the anvil roller 11 simultaneously engage the upper surface of the top sheet and apply a downward force at discrete locations on the material's surface in accordance with the pattern of projections.

In addition to the material being subjected to localized compression by the pattern of projections, the projections may be heated to assist in sealing the sheets of material together.

One of the industrial applications where knurling is commonly employed is in the commercial production of disposable sanitary absorbent articles. Disposable sanitary absorbent articles are articles designed to be placed against the body of a wearer in order to absorb and retain fluids. Examples include, among others, sanitary napkins, panty liners, adult incontinence briefs, infant diapers, and wound dressings. Typically, these articles are of laminate construction comprising two or more layers of material united together to form an integral structure. For example, sanitary napkins commonly comprise a fluid-permeable cover layer intended to face the body of a wearer when the sanitary napkin is in use, a liquid-impervious barrier layer intended to face the undergarment of the wearer when the sanitary napkin is in use, and an absorbent system intermediate the fluid-permeable cover layer and the liquid-impervious barrier layer. Many other layers or structures may also be present. The fluid-permeable cover layer and the liquid-impervious barrier layer are united together around the periphery of the absorbent system to form a peripheral seal.

The commercial-mass production of these articles typically proceeds in the following manner. A web comprising the component materials of the article is formed. This web will have at least two and possibly more sheets of continuous material. It will also include discrete (discontinuous materials), for example, those which form the absorbent system. The continuous sheets are repeatedly united together around the absorbent systems to form seals. Final discrete articles are then severed from the web by cutting around or partially through the seals. The seal around each absorbent system thus forms the peripheral seal in the final article.

Given the speed at which it is desired to manufacture these articles, the aforementioned seals are formed via a conventional knurling process. The knurling process is carried out at a sealing station comprising a die roller and an anvil roller as described above. The projections are arranged on the die roller so as to project in the pattern of the peripheral seal to be formed about the absorbent systems. Typically, there are several of these patterns of projections about the cylindrical surface 5 of the die roller 3, each pattern capable of registering with a successive absorbent system in the web.

In practice, it has been found that conventional knurling pattern designs produce unsatisfactory seals, either because the seals are not strong enough and fail to hold, or because the material has been pierced by the projections such that the seal contains pin holes.

The problem of poor quality sealing is believed to reside in the material selection and the force exerted between rollers. In this respect, the seal strength is adjusted by varying the force exerted between the die roller and the anvil roller or the type and/or thickness of the material used. Attempts have been made to find the correct force and choice of material that forms a proper seal without piercing the material. Despite these efforts the problem of poor quality seals continues to exist.

### SUMMARY OF THE INVENTION

Under a first broad aspect, the present invention provides a die for impressing a material between the die and an anvil such as to apply a compressive force thereto. The die comprises a plurality of defined spatial fields. Each of the fields includes at least two projections arranged within the spatial field, the projections within a field being structured and arranged to engage the material substantially simultaneously. The projections within each field are structured and arranged such that the pressure on the material in each field is maintained within a specified range. In particular, the pressure on the material within each field is not more than double the pressure on the material in any other individual field.

Under a second broad aspect, the present invention provides a method of making a die for impressing a material at a plurality of discrete locations. The die comprises a plurality of defined spatial fields that each include a plurality of projections. Each field has at least two projections arranged on the die to engage the material substantially simultaneously. The method comprises defining a maximum pressure to be applied to the material by any one of the fields of projections and determining a minimum total contact area of projections within any one of the fields, based at least in part on the maximum pressure. The method also involves arranging the projections within the fields of the die based at least in part on the determination. The method further includes structuring and arranging the projections such that the pressure on the material within each field is not more than double the pressure on the material in any other field.

Under a third broad aspect, the present invention provides a method of impressing a material at a plurality of discrete locations in the manufacture of an article including the material. The method comprises providing a die having a plurality of defined spatial fields. Each of the fields has at least two projections arranged to engage the material substantially simultaneously. The method further comprises applying in succession each of the plurality of fields of projections to the surface of the material such as to apply a compressive force thereto. The method further includes structuring and arranging the projections such that the pressure on the material in each field is not more than double the pressure on the material in any other field.

### BRIEF DESCRIPTION OF THE DRAWINGS

Non-limiting examples of implementation of the present invention will now be described with reference to the drawings in which:

FIG. 1 shows a side view of an apparatus for sealing material, in accordance with the prior art;

FIG. 2 shows a front view of the knurling apparatus shown in FIG. 1;

FIG. 3a shows a plan view of a sanitary napkin in accordance with the prior art;

FIG. 3b shows a cross-section through the sanitary napkin of FIG. 3a;

FIG. 4 shows a plan view of a sealing arrangement on a die roller in accordance with an example of implementation of the present invention;

FIG. 5 shows the die roller of FIG. 4 showing additional features thereof;

FIG. 6 is an enlarged view of the section of the die roller contained in the circle shown in FIG. 5;

FIG. 7 shows a perspective view of a die roller in accordance with an example of implementation of the present invention;

FIG. 8 shows a plan view of a sanitary napkin to which the knurling pattern of FIGS. 4 to 6 has been applied;

FIG. 9 is an enlarged view of an example of a knurling pattern contained in the circle labelled “FIG. 9” shown in FIG. 6;

FIG. 10 shows a portion of a side view of a die roller having the knurling pattern of FIG. 9 applied thereto;

FIG. 11 is an enlarged view of an example of a knurling pattern contained in the circle labelled “FIG. 11” shown in FIG. 6;

FIG. 12 shows a portion of a side view of a die roller having the knurling pattern of FIG. 11 applied thereto.

In the drawings, preferred embodiments of the invention are illustrated by way of examples. It is to be expressly understood that the description and the drawings are only for the purpose of illustration and as an aid to understanding. They are not intended to be a definition of the limits of the invention.

### DETAILED DESCRIPTION

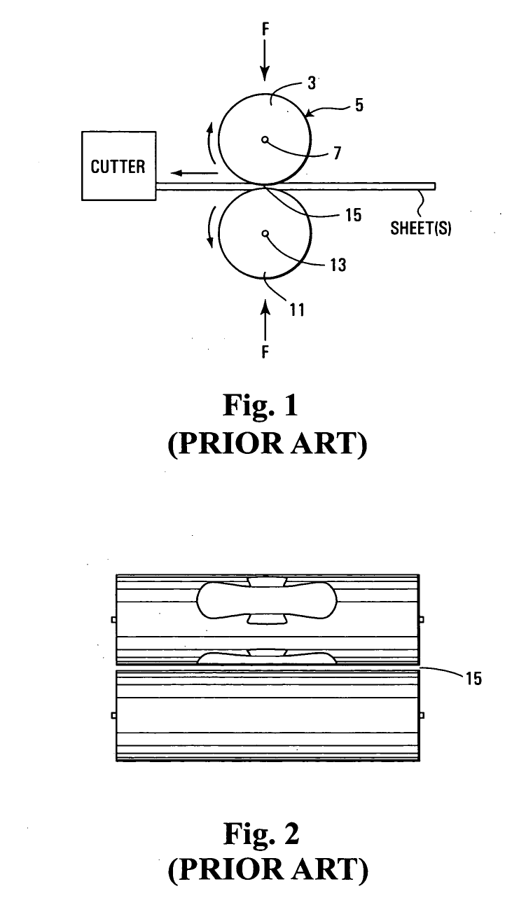

The apparatus and method for knurling according to the present invention will be described, for exemplary purposes, in the context of the manufacture of a sanitary napkin. However, prior to describing the apparatus and method for knurling according to the present invention, a conventional knurling process used in the manufacture of a sanitary napkin will be described with reference to FIGS. 1-3b.

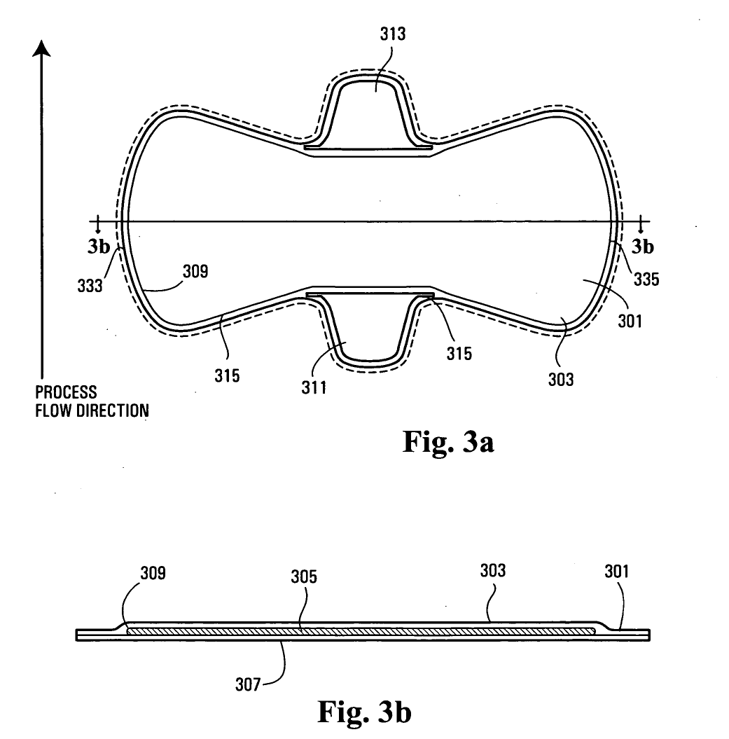

Referring to FIGS. 3a and 3b, a conventional sanitary napkin 301 comprises a liquid permeable, body-facing top sheet 303, an absorbent system 305 adjacent the top sheet 303 and a lower, liquid impermeable back sheet 307 adjacent the absorbent system 305. The top sheet 303 and the back sheet 307 extend beyond a peripheral edge 309 of the absorbent system 305 to form two opposed laterally extending flaps 311, 313, and are joined to form a continuous peripheral seal 315 around the absorbent system 305 and around the edge of each flap 311, 313.

In a conventional manufacturing process, the peripheral seal 315 is formed by, for example, impressing a pattern of knurling projections in the material of the top sheet 303 and the back sheet 307 with the knurling apparatus shown in FIGS. 1 and 2 in order to apply pressure between the top sheet 303 and the back sheet 307.

In a conventional knurling process, the quality of the peripheral seal 315 is optimised by selecting the appropriate materials for the top sheet 303 and back sheet 307 and setting the force applied to the material through the die roller at a value which is sufficient to bond the top sheet 303 to the back sheet 307, to thereby form the peripheral seal 315. However, the knurling projections that form conventional knurling patterns are uniform. As such, depending on the region of the napkin 301 that is being engaged by the die roller, the contact area over which the die roller applies compressive force to the napkin 301 is different. For example, when the die roller engages the napkin 301 along its sides, it engages the napkin 301 over a larger contact area than when it engages the napkin 301 at ends 333 and 335. As such, since the compressive force applied by the die roller to the material is constant, the portion of the material that forms the peripheral seal 315 along the sides of the sanitary napkin will have experienced less pressure than the material that forms the peripheral seal at the ends 333 and 335. The inventors have discovered that a lower pressure tends to form a weaker peripheral seal 315. As such, if the force applied to the die roller is set optimally for the portion of the material that forms the peripheral seal 315 at ends 333, 335 of the napkin 301, a lower pressure will be exerted on the material that forms the peripheral seal 315 along the sides of the napkin 301, thereby forming a weaker peripheral seal 315 at the sides. However, if the compressive force applied to the die roller is set optimally for the portion of the material that forms the peripheral seal 315 along the sides of the napkin 301, the pressure applied to the material along the ends 333, 335 of the napkin 301 will be considerably higher and may possibly puncture the material in that region. The present invention attempts to alleviate these drawbacks.

Briefly, the apparatus for knurling according to a preferred embodiment of the present invention overcomes the drawbacks of the prior art by providing a die roller having a plurality of spatial fields, each spatial field having a plurality of projections arranged therein. The projections in each field are structured and arranged so that the total contact area between the projections and the material in each field is such that the pressure applied to the material in each field is maintained in a specified range. In particular, it is desirable that the total contact area in each field is such that the pressure applied to the material in any individual field is not more than double the pressure applied to the material in any other individual field. More particularly, it is desirable that the pressure applied to the material in any individual field does not exceed the pressure applied to the material in any other field by more than 50%. More preferably, it is desirable that the pressure applied to the material by any individual field does not exceed the pressure applied to the material by any other field by more that 30%, and most preferably it is desirable that the pressure applied to the material in each of the fields is substantially equal.

To achieve the above objectives, at least one of the size of the individual contact area for each projection, the number of projections within each field and the spacing between projections in each field is selected so that the total contact area between the projections and the material in each field is such that the pressure experienced by the material in each of the fields is maintained within the specified range, as set forth above.

The die roller, as described in greater detail below, may optionally further include “islands” of additional projections that are adapted to reduce the pressure applied to the material in selected fields.

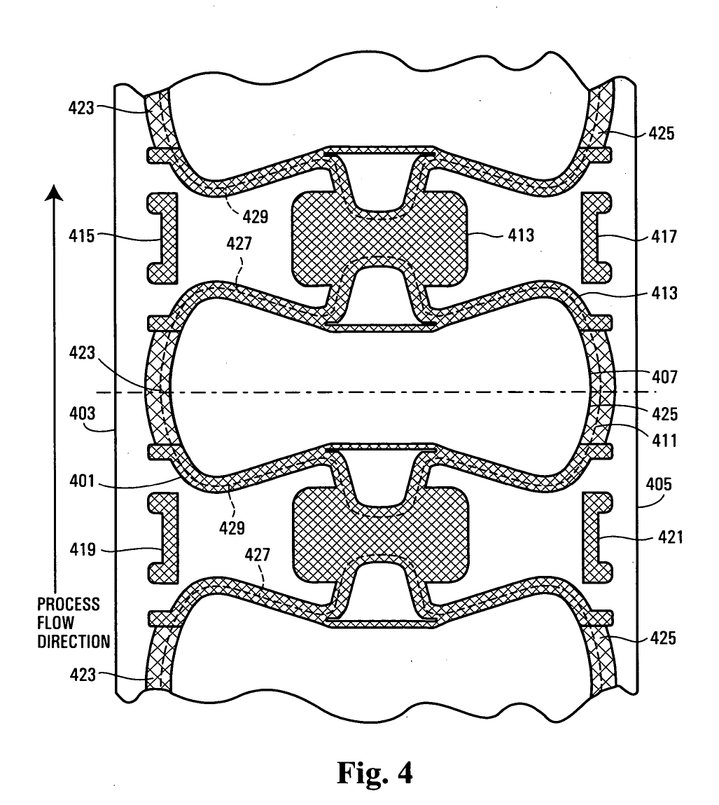

FIG. 4 shows a portion of a surface of a die roller that includes a sealing pattern 401 used to form a peripheral seal around a sanitary napkin in accordance with an example of implementation of the present invention. It should be understood that although FIG. 4 shows the sealing pattern 401 such that the sealing arrangement for each napkin is arranged in a side-by-side relationship, wherein the longitudinal side edge 427 of one sealing arrangement faces the longitudinal side edge 429 of another sealing arrangement, in an alternative example of implementation, the sealing arrangement for each napkin can be arranged in an end-to-end relationship, wherein the end 423 of one sealing arrangement faces the end 425 of another sealing arrangement.

The sealing pattern 401 shown in FIG. 4, is bounded by two sides 403, 405, which may, for example, represent opposite ends of a die roller. The shaded areas show the regions that include projections and the blank areas show the regions that contain no projections. The projections are configured to define an internal seal boundary 407 that corresponds generally to the outline of the main body of a sanitary napkin. A dashed line represents an imaginary boundary 411 that corresponds to the peripheral edge of the sanitary napkin. The sealing pattern 401 is sufficiently wide such that zones of projections lie within the imaginary boundary 411 and zones of projections lie outside the imaginary boundary 411. The sealing pattern 401 also has an external seal boundary 413. The sealing pattern 401 optionally further includes discrete islands 415, 417, 419, 421 of projections located near ends 423, 425 of the sealing pattern 401 and offset toward each longitudinal side edge 427, 429.

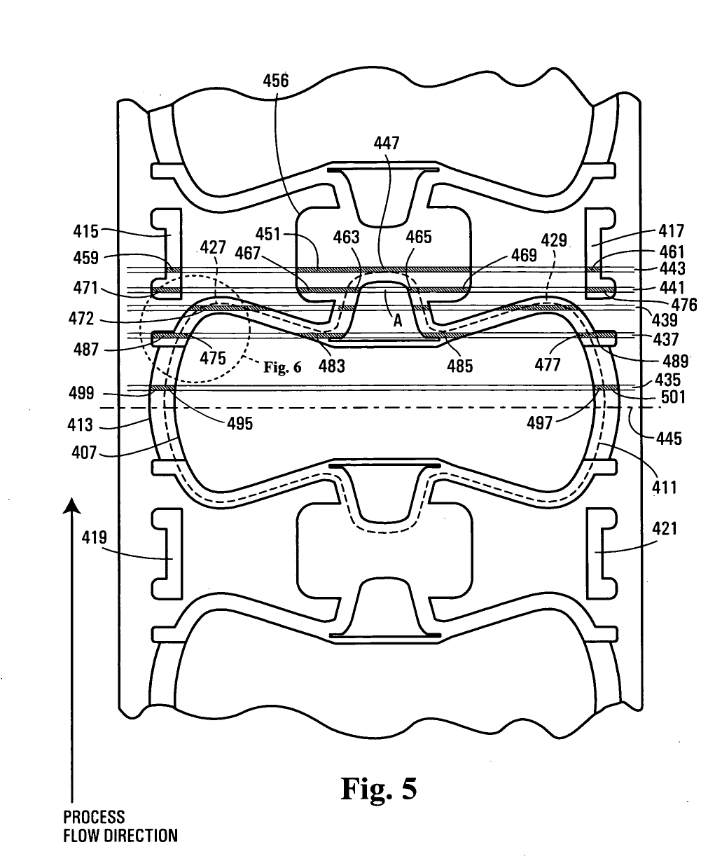

As shown in FIG. 5, the die containing the sealing pattern 401 includes a plurality of fields, such as fields 443, 441, 439, 437 and 435, for example, that each contain zones of projections that together form the sealing pattern 401 shown in FIG. 4. Although the fields are shown in spaced relationship in FIG. 5 for clarity, it is to be understood that the surface of the die would include a plurality of adjacent fields over the surface of the die so as to form the repeating sealing pattern as shown. Thus, for example, although not shown in FIG. 5, a plurality of adjacent fields are located between fields 435 and 437, 437 and 439, 439 and 441 and so forth.

The fields 435, 437, 439, 441, 443 contain zones of projections, which are capable of engaging a material to be impressed substantially simultaneously. The projections within different fields are arranged on the die to engage the material at different times. The fields of projections are progressively spaced from and run generally parallel to a longitudinal axis 445 of the sealing pattern 401, the longitudinal axis 445 being parallel to the rotation axis of the die. In the case where the sealing pattern 401 is positioned end to end, as described above, the fields of projections run parallel to the axis of rotation of the die.

Each of the fields 443, 441, 439, 437, and 435 shown in FIG. 5, include two or more zones of projections. For the purposes of the present application, a zone includes a plurality of projections that are contained within the sealing pattern 401 or that are contained within the optional islands 415, 417, 419 or 421. As for the zones contained within the sealing pattern 401, the boundary of a zone begins at either the internal periphery 407, the external periphery 413 or the imaginary boundary 411 and ends when the plurality of projections meets either one of the internal periphery 407, the external periphery 413 or the imaginary boundary 411. As such, a zone can be bounded by the external periphery 413 and the imaginary boundary 411, which is the case for zone 487, or can be bounded by the internal periphery 407 and the imaginary boundary 411, which is the case for zone 475. Alternatively, a zone can be bounded solely by the imaginary boundary 411, as is the case for zone 472, or a zone can be bounded solely by the internal periphery 407, as is the case for zones 483 and 485. In addition, a zone can be bounded solely by the external periphery 413, as is the case for zone 451.

Field 443, whose projections form a seal near an extreme lateral edge 447 of a flap portion of the sealing pattern 401, includes zone 451 of projections which extends beyond the end of the flap portion of the sealing pattern 401. The field 443 also includes two discrete zones 459, 461 of projections contained within islands 415 and 417, that are discontinuous and remote from zone 451. A zone is said to be discontinuous and remote from another zone when there is a space located between the two zones that does not contain any projections.

The zones 459, 461 of projections are located towards each end of the sealing pattern 401 and contained within optional islands 415, 417, respectively. The projections of the field 443 that are located outside of the flap portion of the sealing pattern 401, such as the projections within the islands 415, 417, serve to provide additional area over which the force of the die roller is distributed. This reduces the pressure applied to the material in field 443. In this manner, the optional islands 415, 417 can be used to selectively reduce the pressure on the material within selected fields by increasing the contact area between the die and the material within a given field. Optional islands 419 and 421 may be used in a similar fashion.

Referring again to FIG. 5, the field 441. includes projections, which form zones 463, 465 that are contained within the imaginary boundary 411 of the sealing pattern 401. This field 441 also has zones 467, 469 of projections that are outside the imaginary boundary 411. Field 441 further includes zones 471, 476 of projections within each island 415, 417 located near the end of the seal pattern 401. Zones 463, 465 of projections are continuous with the zones 467, 469 of projections, respectively. The field 439 contains projections that are distributed in several zones located either within the imaginary boundary 411 or outside the imaginary boundary 411. Notably, the field 439 engages a significant portion of the sealing portion 401 area between the internal and the external seal boundaries 407, 413. Therefore, it is not necessary to extend the discrete optional islands 415, 417 to encompass the field 439 since the total geometric area defined by field 439 is similar to that within the field 441.

The field 437 contains two discrete zones 483, 485 of projections each within the imaginary boundary 411 and four further zones 475, 477, 487, 489 of projections. The zones 475, 477 of projections are within the imaginary boundary 411 and they are continuous with the zones 487, 489 of projections, respectively, that are outside the imaginary boundary 411. The zones 483, 485 of projections are discontinuous and remote from the zones 475, 477, 487, 489 of projections.

The field 435, which is located near the longitudinal axis 445 of the sealing pattern 401, contains two zones 495, 497 of projections within the imaginary boundary 411. The field 435 further includes zones 499, 501 of projections which extend outside the imaginary boundary 411 and which are continuous with the zones 495, 497 of projections, respectively. The sum of geometric areas defined by zones 495, 497, 499, 501 is substantially less than the sum of the geometric areas defined by the other fields 437, 439, 441 and 443.

Since the sum of the area of zones 495, 497, 499 and 501 in field 435 is significantly less than the sum of the area of the zones in the other fields, the pressure on the material in field 435 would be significantly higher if the projections were uniform in all of the fields. To prevent this phenomena at least one of the size individual contact area for each projection, spacing and number of projections in each field is selected so that the total contact area in each of the fields is such that the pressure experienced by the material in each of the fields is maintained within a specified range. In particular, the projections are structured and arranged such that the pressure applied to the material by any individual field is not more than double the pressure applied to the material by any other field.

For example, the projections in the zones 495, 497, 499, 501 of field 435 may be arranged such that they have larger individual contact areas than the projections in fields 443, 441, 439 and 437 to thereby increase the total contact area in field 435 and thereby reduce the pressure on the material in this field. Alternatively, the projections in the zones 495, 497, 499, 501 of projections may be spaced more closely to one another than the projections in the fields 443, 441, 439 and 437 to thereby increase the total contact area in field 435. Yet another alternative is to include a greater number of projections in zones 495, 497, 499 and 501 of field 435 to thereby increase the total contact area in field 435. By using one or more of the above techniques, although the total geometric area of field 435 is significantly less than the total geometric area of any one of fields 443, 441, 439 and 437, the total contact area in field 435 may be increased so that it is similar to the contact area of fields 443, 441, 439 and 437. As such, the pressure applied to the material in field 435 will be maintained within the specified range of pressures.

Obviously, the approaches described above may be combined, if necessary. For example, the projections in a given zone may be spaced more closely together and the size of the individual contact area of the projections within the field may be increased to thereby increase the total contact area in the selected field.

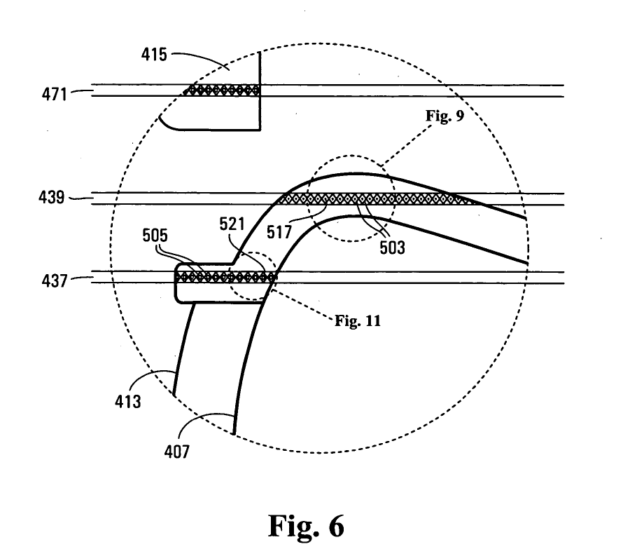

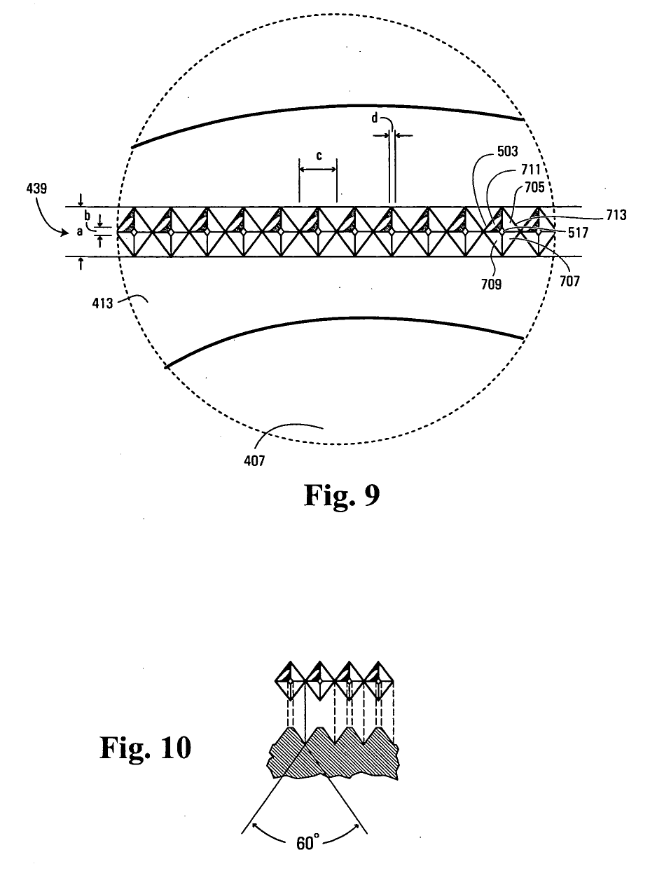

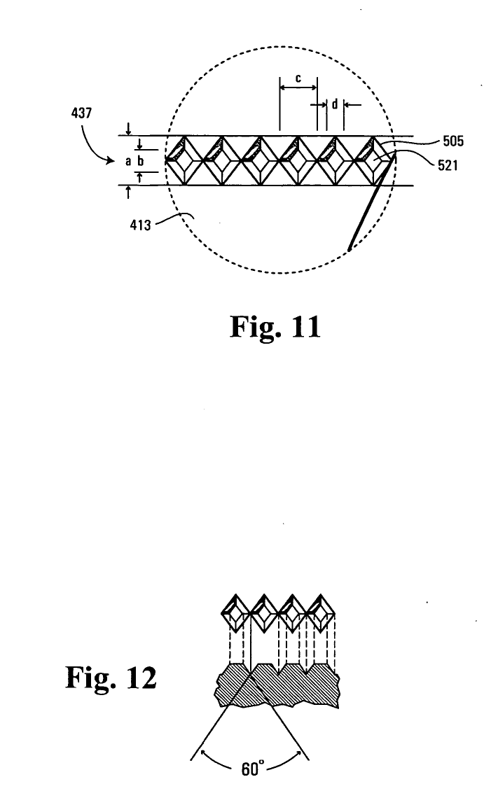

FIG. 6 is an enlarged view of the portion of the die roller contained in the circle designated “FIG. 6” in FIG. 5. FIG. 6 shows the projections contained in selected portions of fields 441, 439 and 437. FIGS. 9 and 11 each show a further. enlarged view of the portion of the die roller contained in the circles designated “FIG. 9” and “FIG. 11” in FIG. 6.

As seen in FIG. 6, the portion of field 439 shown, includes projections which extend over a larger overall geometric area of the napkin than the projections in the portion of field 437 shown. Also in this specific embodiment of the invention, as best seen in FIGS. 9 and 11, the individual size of each of the projections 503 in field 439 is the same as individual size of each of the projections 505 in field 437. Further, the spacing between each of the projections 503 and each of the projections 505 is substantially the same. Consequently, there are a greater number of projections 503 in the portion of field 439 shown in FIG. 6 than the number of projections 505 in the portion of field 437 shown in FIG. 6.

However, as best seen in FIGS. 9 and 11, it should be noted that the individual contact area 517 of each projection 503 in field 439 is smaller than an individual contact area 521 of the projections 505 within field 437. As such, as discussed in greater detail below, the overall contact area in field 439 is similar to the overall contact area in field 437. In this manner the pressure applied in field 439 and in field 437 is maintained substantially constant.

In a non-limiting example of implementation, the shape of the contact surfaces of the projections 503 and 505 is generally rhomboidal. However, it should be understood that other shapes may be used such as squares, circles, triangles, ellipses or any other suitable shape, without departing from the spirit of the invention. Furthermore, the contact area of one or more projections 503, 505 within a given field may be different from that of one or more other projections 503, 505 within the same field. Furthermore, the spacing between two or more immediately adjacent projections 503, 505 within a given field may be different from the spacing between two or more other projections within that same field. It should be understood that the spacing between each projection in a zone can vary. As such, the average spacing between projections is determined by adding up all the spacings and dividing that sum by the number of spacings that were added together.

FIG. 9 shows an enlarged plan view of a field of projections 503 which may be used within zone 472 of field 439, for example, and FIG. 10 shows a partial side view of a die roller having the knurling pattern of FIG. 9. As shown, each projection is generally shaped as a truncated pyramid and has four side faces 705, 707, 709, 711 tapering upwardly from each side of a rhombic shaped base 713 to a smaller rhombic shaped individual contact area 517. The rhombic shaped individual contact surface 517 is elongate along one direction.

In a non-limiting embodiment, the width of the field “a” is approximately 2 mm, the width of each projection “b” is approximately 0.8 mm, the overall length of each projection “c” is approximately 1.16 mm, and the length of each projection “d” is approximately 0.46 mm. The contact area 517 of the projection 503 is a rhombus and thus its geometric area can be calculated as follows A=½ (b) (d). As such, the overall projection contact area for each projection 503 is approximately 0.184 mm².

FIG. 11 also shows an array of projections 505 which may be used within zone 487 of field 437, for example, and FIG. 12 shows a partial side view of a die roller having the knurling pattern of FIG. 11 applied thereto. Referring to FIGS. 11 and 12, each projection has four tapering sides extending upwardly from a rhombic shaped base to a generally flat, rhombic shaped individual contact area 521. The individual contact area 521 of each projection 505 in FIGS. 11 and 12 is larger than that of the individual contact area 517 of the projections 503 shown in FIGS. 9 and 10.

In the non-limiting embodiment shown in FIG. 11, the width of the field “a” is approximately 2 mm, the width of each projection “b” is approximately 1.15 mm, the overall length of each projection “c” is approximately 1.16 mm, and the length of each projection is “d” is approximately 0.66 mm. The contact area 521 of the projection is a rhombus and thus its area can be calculated as follows A=½ (b) (d). As such, the overall projection contact area is approximately 0.3785 mm².

Referring back to FIG. 6, there are approximately twice as many projections 503 in the portion of field 439 shown, as there are projections 505 in the portion of field 437 shown. However, since the projections 505 have approximately twice the contact area of projections 503, the overall contact area for the portions of fields 439 and 437 shown, will be approximately the same.

Increasing the total contact area of projections within each of the other fields may be achieved in any one of the techniques described above, individually or in combination. For example, one or more additional projections may be added to each field external of the imaginary boundary corresponding to the peripheral edge of the article. The contact area of some or all of the projections within the other fields may be increased or the spacing between immediately adjacent projections may be decreased.

The pattern of projections for producing a seal around the peripheral edge of a sanitary napkin, shown in FIG. 4, is preferably applied to a die roller. Depending on the diameter of the die roller, the pattern may be repeated a number of times over the surface of the roller. Preferably the beginning of the pattern for one article is close to the end of the preceding pattern for another article, in order to facilitate the speed of processing and to avoid the wastage of materials.

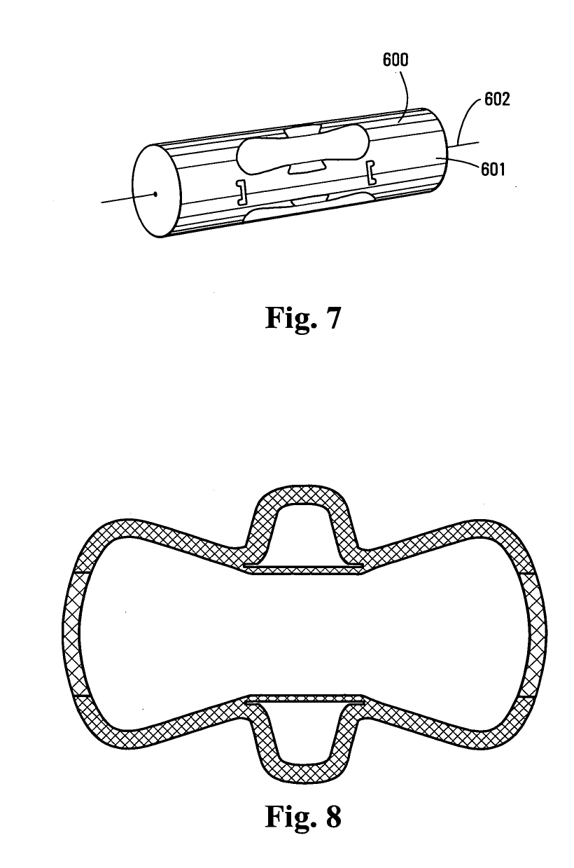

An example of a die roller 600, otherwise known as a rotary die, containing the seal pattern of FIG. 4 is shown in FIG. 7. The die roller 600 has a cylindrical surface 601 and an axis of rotation 602 about which the cylindrical surface 601 can rotate. Knurls or projections 503 and 505, as shown in FIG. 6, are provided over the cylindrical surface 601 of the die roller 600. The knurls or projections 503 and 505 may be formed integrally with the surface of the cylinder by any suitable process, for example, machining (such as milling) or any other process known to those skilled in the art. Alternatively, the knurls or projections 503 and 505 may be formed separately from the die roller 600, for example, on a sheet of material which is then wrapped around the die roller 600 and fastened thereto by any suitable fastening means.

The die roller 600 may be incorporated in any conventional knurling apparatus, such as that shown in FIGS. 1 and 2 to progressively seal together material such as the top sheet 303 and back sheet 307 in the manufacture of a sanitary napkin. After sealing, the sealed laminated web may be passed to a cutter to cut the article out of the web. An example of a sanitary napkin having a peripheral seal formed by the embodiment of the die roller shown in FIG. 7, is shown in FIG. 8.

The design and manufacture of a die, according to an example of implementation of the present invention will now be described in more detail. For the purposes of the non-limiting example described below, the knurling process is used to create a peripheral seal between a top sheet made of a polypropylene fiber blend having approximately a 2% level of TiO₂, and a back sheet made of polyethylene homopolymers (metallocene catalysed film). It should, however, be understood that the knurling process can also be used to form a peripheral seal in other suitable materials used for forming sanitary napkins.

In a first step of designing a die, the regions within the sealing pattern, which are to be subjected to a knurling process, are identified and then each region is divided into a plurality of fields each having a selected width. In a non-limiting embodiment, the width of each field is in the order of 2-3 mm.

The total geometric area defined by each of the fields can then be calculated by multiplying the width of the field by the length of the field. The total geometric area defined by each field is important to know when distributing the projections within the field. In a non-limiting embodiment, the length of a field can be defined as the sum of the length of the zones within that field. As such, the length of each field will depend on where along the sealing arrangement the field lies. For example, it will be appreciated that the length of field 441 will be greater than the length of the field 435, as shown in FIG. 5.

Another preliminary step when designing a die roller is to establish a pressure range that can be applied to the material. The pressure range may be defined by a maximum and minimum pressure that can be applied to the material being sealed.

In a specific example of implementation, the maximum pressure can be defined as the pressure above which the material is likely to be punctured by the projection. Alternatively, when embossing the material, the maximum pressure can be defined as the pressure required to form an impression in the material of a predetermined depth.

The minimum pressure can be defined as the pressure required to form a seal in the material having a predetermined minimum tensile strength. When the material includes two or more sheets sealed to one another the tensile strength of the seal is determined by pulling the sheets away from one another at the seal and noting the level of force being applied when the seal breaks. In general, for the material described above, it is desirable for the finished napkin to have a seal strength of approximately 59 g/cm. A critical minimum seal strength is generally considered to be in the order of 39 g/cm.

In an optional embodiment, a possible variation in pressure between different fields can also be established.

In a non-limiting embodiment wherein the die roller is used to knurl the materials described above, the minimum and maximum pressure that can be exerted on the material are in the order of 41000 psi and 68000 psi.

Once the pressure range has been established, the compressive force applied by the die roller is determined. In a non-limiting embodiment wherein the die roller is used to knurl the materials described above, the die roller can have a set point pressure of between 60 psi to 80 psi. If the pressure is set at 80 psi with an air cylinder of 6 inches, the force applied by the die roller will be in the order of 2262 lb. It should be understood that a different force can be set depending on multiple different parameters of the knurling process, such as the materials being sealed together, the weight of the die roller, the mechanical force applied to the die roller via an external element, etc.

Given that the force applied to the material by the die roller is known, the pressure applied to the material can be maintained within the desired pressure range by controlling the contact area within each field of the die roller. Increasing and decreasing the total contact area of projections within each of the fields may be achieved by any one of the techniques described above, individually or in combination. For example, one or more projections may be added or subtracted to each field, the contact area of some or all of the projections within the fields may be increased or decreased, or the spacing between immediately adjacent projections may be increased or decreased. As such, the contact area within each field can be controlled by adjusting the size, spacing and quantity of projections within that field.

The amount of contact area required in each field, such that the pressure exerted on the material is within the established pressure range, can be calculated using the formula of Area=Force/Pressure. It should be understood that it is desirable to keep the pressure (in psi) applied to the material within each of the fields at no more than double the pressure (in psi) applied to the material within any other one of the plurality of fields.

Once the contact area has been calculated, the number of contact projections can be calculated by dividing the total contact area by the contact area of each projection. In a non-limiting example of implementation, each projection can have a contact area of between 0.13 and 0.49 mm².

In general, only a single row of projections will lie in each field. As such, the manner in which the projections are distributed within a field can be determined based on the length of the field and the length of the projections. Based on this information, a uniform amount of spacing between each projection can be calculated. As such, the projections can be equally spaced within each field. In an alternative embodiment, it should be understood that it is not necessary that the projections within a field be equally spaced. For example, the projections may be equally spaced within a first zone of a field by a first spacing, and may be equally spaced within a second zone of the field by a second spacing that is different from the first.

In addition, the spacing can be of a certain length in the largest field, and that certain spacing can be reduced proportionally in the other fields on the basis of the length decrease of the field. As such, the same number of projections can be fit within each field, regardless of the size of the field.

In other possible variants, projections may be arranged to form recesses in the surface of the material as, for example, in an embossing pattern. In contrast to a sealing operation, an embossing operation does not aim primarily to join sheets of material, but mainly to create alternating peaks and valleys in the material. The embossing pattern may be formed across portions of an article such as the sanitary napkin 409 of FIG. 4, or alternatively across the entirety of the article. Again, the projections may be arranged such that the total contact area of projections in any field simultaneously in contact with the material apply a predetermined pressure to the material to create an embossed recess having a predetermined depth. In this way, the principles of the present invention may be employed to improve control over embossing processes. In other variants, the principles of the present invention may be used to control simultaneously the production of a seal between two materials and the embossing of an article. For example, a pattern of projections may be provided on a single die, some of which are used to form a seal and others used to form an embossing pattern.

Other embodiments and further modifications to the embodiments described above will be apparent to those. skilled in the art.

1. A die for impressing a material between said die and an anvil such as to apply a compressive force thereto, said die comprising:
a plurality of fields, each of said fields including at least two projections arranged to engage the material substantially simultaneously;
wherein said projections are structured and arranged such that a pressure on the material within each of the fields is not more than double the pressure applied to the material within any other one of said plurality of fields.

2. A die as defined in claim 1, wherein the pressure on the material within each of the fields is not more than 30% greater than the pressure on the material within any other one of said plurality of fields.

3. A die as defined in clam 1, wherein the pressure on the material within each of said plurality of fields is substantially equal.

4. A die as defined in claim 1, wherein the projections arranged within a selected one of said fields are structured and arranged to contact said material at substantially the same time and the projections arranged in different ones of said plurality of fields are structured and arranged to contact said material at different times.

5. A die as defined in claim 1, wherein said die is a rotary die.

6. A die as defined in claim 1, wherein at least one field of said plurality of fields includes a first zone of projections within an imaginary boundary and a second zone of projections external to said imaginary boundary, said imaginary boundary corresponding to a peripheral edge of an article.

7. A die as defined in claim 6, wherein said first zone is continuous with said second zone.

8. A die as defined in claim 6, wherein said first zone is discontinuous and remote from said second zone.

9. A die as defined in claim 1, wherein said plurality of fields define a sealing pattern for impressing a material of a sanitary absorbent article to form a peripheral seal extending at least partially around the sanitary absorbent article.

10. A die as defined in claim 9, wherein said sealing pattern includes a portion shaped as a main body of a sanitary napkin and a portion shaped as a flap of a sanitary napkin.

11. A die as defined in claim 4, wherein said rotary die has an axis of rotation, each of said fields of projections extending generally parallel to said axis of rotation.

12. A die as defined in claim 1, wherein a spacing between immediately adjacent projections in a first selected one of said fields of projections is different from a spacing between immediately adjacent projections in a second of said fields of projections.

13. A die as defined in claim 1, wherein each of said projections has an individual contact area that contacts said material, and wherein a total contact area of a field is defined by a summation of all of the contact areas of all the projections within said field.

14. A die as defined in claim 13, wherein the total contact area within each of said fields is selected such that the pressure applied to the material within each of the fields is not more than double the pressure applied to the material within any other one of said plurality of fields.

15. A die as defined in claim 14, wherein a size of at least one of the projections in one of said plurality of fields is different than a size of at least one of the projections in another one of said plurality of fields.

16. A die as defined in claim 14, wherein a spacing between adjacent ones of said plurality of projections within a first one of said plurality of fields is different than a spacing between adjacent ones of said plurality of projections within a second one of said plurality of fields.

17. A die as defined in claim 14, wherein a number of projections within a first one of said plurality of fields is different than a number of projections within a second one of said plurality of fields.

18. A sanitary napkin manufactured by the die of claim 1.

19. A method of making a die for impressing a material at a plurality of discrete locations, the die comprising a plurality of fields of projections, each field of projections having at least two projections arranged on said die to engage the material substantially simultaneously, the method comprising:
defining a maximum pressure to be applied to the material by any one of said fields of projections;
determining a minimum total contact area of projections within any one of said fields of projections through which the pressure is to be applied to the material based at least in part on the maximum pressure; and
arranging the projections within the fields of said die based at least in part on said determination.

20. A method of making a die as defined in claim 19, wherein the projections of different fields are arranged to engage the material at different times.

21. A method of making a die as defined in claim 19, further comprising:
defining a minimum pressure to be applied to the material by any one of said fields of projections;
determining a maximum total contact area for any one of said fields of projections based at least in part on the minimum pressure; and
forming said fields of projections on said die such that the total contact area of projections of each of said fields of projections is less than or equal to said maximum total contact area.

22. A method of making a die as defined in claim 21, wherein said maximum pressure is defined as a pressure above which the material is punctured by said projections.

23. A method of making a die as defined in claim 21, wherein said maximum pressure is defined as a pressure required to form a depression in the material of a predetermined minimum depth.

24. A method of making a die as defined in claim 21, wherein said minimum pressure is the pressure required to form a seal in the material having a predetermined minimum tensile strength.

25. A method of impressing a material at a plurality of discrete locations in the manufacture of an article including the material, said method comprising:
providing a die having a plurality of fields, each of said fields having at least two projections arranged to engage the material substantially simultaneously;
applying in succession each of said plurality of fields of projections to the surface of the material such as to apply a compressive force thereto;
said projections in each of said plurality of fields of projections defining a total contact area over which the compressive force is applied;
the total contact area of the projections in each field being such that the pressure applied by each individual field on said die is not more than double the pressure applied by any other individual field on said die.

26. A method as defined in claim 25, wherein the pressure applied by each individual field on said die exceeds at most by 60% the pressure applied by any other individual field on said die.

27. A method as defined in claim 265, wherein the projections of different fields are arranged on the die to engage the material at different times.

28. A method as defined in claim 25, wherein the die is a rotary die.

29. A method as defined in claim 25, wherein at least one field of said plurality of fields includes a first zone of projections within an imaginary boundary and a second zone of projections external to the imaginary boundary, the imaginary boundary corresponding to a peripheral edge of the article being manufactured.

30. A method as defined in claim 29, wherein said first zone is continuous with said second zone.

31. A method as defined in claim 29, wherein said first zone is discontinuous and remote from said second zone.

32. A method as defined in claim 25, wherein said fields define a sealing pattern for impressing the material of the article to form a peripheral seal extending at least partially around the article.

33. A method as defined in claim 32, wherein said sealing pattern includes a portion shaped as a main body of a sanitary napkin and a portion shaped as a flap of a sanitary napkin.

34. A method as defined in claim 28, wherein said rotary die has an axis of rotation, each of said fields of projections extending generally parallel to said axis of rotation.

35. A method as defined in claim 25, wherein a spacing between immediately adjacent projections in a first of said fields of projections is different from a spacing between immediately adjacent projections in a second of said fields of projections.

36. A method as defined in claim 25, wherein a first of said fields of projections has a plurality of projections each having a first individual contact area, and a second of said fields of projections has a plurality of projections each having a second individual contact area, said first individual contact area being different from said second individual contact area.

37. A method as defined in claim 25, wherein the material includes a fluid-pervious layer and a liquid-impervious layer.

38. A method as defined in claim 37, wherein the impressing forms a seal joining. the fluid-pervious layer and the liquid-impervious layer.
